(19) United States
(12) Patent Application Publication
(10) Pub. No.: US 2004/0236643 A1
(43) Pub. Date: Nov. 25, 2004

(54) Information system for the dynamic management of bulk products

(76) Inventors: Marie-Caroline Dick, Bourg La Reine (FR); Frederic Rotman, Paris (FR); Christian Muratet, Paris (FR)

Correspondence Address: Linda K. Russell, Air Liquide, Suite 1800, 2700 Post Oak Blvd., Houston, TX, 77056, US

(21) Appl. No.: 10/446,277

(22) Filed: May 23, 2003

(51) Int. Cl. G06F 17/60

(52) U.S. Cl. 705/28

(57) ABSTRACT

The invention relates to a control system for at least one production unit (3) of at least one product, on the basis of consumption data of the said product by at least one unit consuming this product, comprising:

storage means (4), for storing data relating to at least the status of stocks of the said product contained in stocking means (7) of the said consumer and to the product requirements of this consumer,

means (16) of calculating consumption prediction data on the basis of the preceding stored data,

means of transmitting this data to the said production unit (3).

### TECHNICAL FIELD AND PRIOR ART

The invention relates to the field of the management of bulk products, and in particular products such as gases, for example cryogenic products in liquid form.

The production of gas by a gas manufacturer is generally a continuous process.

Similarly, the industrial processes of users of such gases are also often continuous. This means that the raw material is a critical element in the production line and therefore it must not block the latter.

Furthermore, in certain cases, a product such as a gas is a critical element regarding the safety of the production process. This is the case for gases, such as nitrogen for example, which must have a minimum continuous flow rate in order to prevent explosions.

The production and stocking sites for such bulk products, and the sites for using these products, are generally separate and not connected by a system. This arrangement is unlike arrangements for the distribution of fluids such as water or natural gas, or even electricity, for which the production and consumption sites are joined by a system.

In the case of bulk products, and in particular of industrial gases, the management of the continuity of both the production and of the consumption is therefore a very technically complex problem.

Furthermore, the regulations regarding dangerous materials usually involve a limitation, in terms of quantity and of time, of the stocking volume, and also restrictions relating to the movement of these materials in space and in time.

Another constraint is that such products are often perishable. This is the case, for example, of chemical formulations or of resins. Transport or stocking times that are too long can therefore result in the loss of the product. For example, in the case of gas, it is possible for there to be a heating up or a vaporization and a venting into the atmosphere through valves.

Safety measures are imposed for the handling and use of certain products. In the case of gas, it will for example be necessary to comply with an adapted filling speed, a minimum and/or maximum pressure, etc. Trained and qualified staff is therefore necessary for correct prevention of risks.

All of these technical matters have repercussions with regard to costs. The cost of transport is an important factor in the cost of the product supplied to the user. The costs of managing and supervising the stocking are also not negligible.

A problem raised is therefore that of finding tools or means allowing a management that is as adapted as possible to the constraints of production and use of bulk products, in particular in the case of industrial gases.

Another problem is that of the centralized management of the supply of a product or products to an industrial site using this product or these products as raw material or materials. In fact, present day industrial sites are increasingly complex, extensive and necessitate supply of raw material at different stocking sites or at different production sites. At the present time, there are no tools making it possible to carry out a centralized control of the supply of raw material to these different sites. Such centralization is however essential for a rational control of these sites.

Neither are there any tools or processes allowing those involved in the production, delivery and utilization processes of these raw materials to communicate.

According to another aspect, for bulk products, the consumer sometimes lacks control of his consumption and is often unable to have information on the relationship between his production and his consumption of the said bulk products.

This is particularly the case when the consumption takes pace at several points (which has already been mentioned above) and/or is associated with different modes of consumption. The anticipation of future requirements is therefore difficult for the consumer and even more difficult for the supplier who has to supply in the context of an objective of no breaks in provision.

Until the present time, the problem of supplying bulk products in this environment has been solved:

by reproducing simple historical delivery arrangements, for example by reproducing the basis of the latest deliveries (delivery time, quantity);

or by remote exchange, for example by telephone link between the customer and the supplier.

### DESCRIPTION OF THE INVENTION

The invention firstly relates to a method of adapting the production, by a unit for producing at least one product, to the consumption of the said product by at least one consumer of that product, comprising:

the storage, in storage means, of data relating to at least the status of stocks of the said product contained in stocking means of the said consumer and to that consumer's product requirements,

the calculation of consumption prediction data on the basis of the preceding stored data.

This data can then be transmitted to the said production unit, or can be consulted remotely.

The production rate of the production unit can then be modified on the basis of the preceding consumption prediction data.

The data relating to requirements can be expressed as a quantity or as a mass or as a volume of product per unit time, for example per day or per week or per month and possibly for a particular duration (for example: 2 tonnes per day for 2 months).

The same applies to the consumption prediction data, which can furthermore relate to a time period such as one or more days, or weeks or months (for example: 3 tonnes per week for two months).

This method furthermore makes it possible to take best account of the technical characteristics of the product, in particular in the case of a dangerous or perishable material.

The invention also relates to a method for supplying a consumer, or a consumer site, or an industrial consumer site, with at least one product consumed by the said consumer or the said site, comprising:

the storage, in storage means, of data relating to at least the status of stocks of the said product contained in stocking means of the said consumer or of the said site, and to that consumer's or that site's product requirements,

the calculation of consumption prediction data on the basis of the preceding stored data,

the generation, preferably automatic, of delivery data of the said product on the basis of the calculated consumption prediction data.

The delivery or supply of product can therefore be adapted to the consumer's requirements.

The invention also relates to a method for adapting a utilization, by a unit consuming at least one product, comprising:

the storage, in storage means, of data relating to at least the status of stocks of the said product contained in stocking means of the said consumer and to the product requirements of that consumer,

the variation of consumption, by the consuming unit, on the basis of the preceding data.

The data contained in the storage means can be transmitted to the said consuming unit, or can be consulted remotely.

The data relating to the requirements and the consumption prediction data can be expressed, as described above, as a quantity or mass or volume per unit time and possibly over a particular duration.

A packaging and transport phase can then take place.

Furthermore, it is also possible to store data on the quantity, volume or mass of products actually delivered.

According to the invention, a production or a supply adapted to the requirements of the consumer industrial site is obtained. This is even more advantageous during a continuous production and/or supply of products, in particular of bulk products, distributed without a fixed distribution infrastructure such as exists in the case of water or of electricity or of natural gas.

The quantities actually available in the stocking means can also be measured and then entered in the storage means, after which the data relating to the status of the stocks and/or the prediction data can also be modified.

The user, that is to say the consumer or the consumer site, can also modify the stored consumption or requirement data, for example after a modification of his work plans or predictions. Here again, the prediction data can therefore be recalculated according to the modified data.

The storage means can also contain production means technical characteristics data on the said consumer using the said product or relating to manufacturing units of the said product.

They can also comprise or store data relating to deliveries of the said product, past and/or current and/or future deliveries.

The user thus has overall technical information, including that on his own installations. The producer and/or supplier can also have this overall technical information.

The invention also relates to a control system for at least one production unit of at least one product, on the basis of consumption data of the said product by at least one unit consuming this product, comprising:

storage means, for storing data relating to at least the status of stocks of the said product contained in stocking means of the said consumer and to the product requirements of this consumer,

means of calculating consumption prediction data, or specially programmed to calculate such data, on the basis of the preceding stored data,

means of transmitting this data to the said production unit.

Furthermore, a production unit of industrial products according to the invention can comprise:

means of production of the said products,

means of communication to establish communication with a system such as described above.

The invention also relates to a system for controlling the provisioning of a unit consuming a product, comprising:

storage means, for storing data relating to at least the status of stocks of the said product contained in stocking means of the said consuming unit and to the product requirements of this unit,

means of calculating consumption prediction data, or specially programmed to calculate such data, on the basis of the preceding stored data,

means for the automatic generation of delivery data of the said product on the basis of the calculated consumption prediction data.

Furthermore, an industrial production unit according to the invention can comprise:

means of stocking products, referred to as first products,

means of production of second products, obtained from the said first products,

means of communication for establishing a data link with a system such as described above.

A system or a unit such as described above can furthermore comprise means of communication between the said measuring means and the said storage means or between the said measuring means and computer means containing these storage means and/or means for establishing a secure link with communications means of a consuming unit and/or means for establishing a secure link with means of communication of a production unit and/or means for establishing a secure link with communications means of a transport means management unit.

The invention also relates to a computer system, or a device for aiding the management of stocks of at least one product according to a consumption of the said product by a user comprising:

storage means storing data on the stocks and consumption of, or requirements for, industrial products by at least one industrial site consuming these products,

connection means for establishing a link or a connection with communications means of at least one site using products, or a production site using these products, and communications means of at least one production site or site for stocking these products.

The link or connection is preferably secure.

Such a device can furthermore comprise means of calculating consumption prediction data, on the basis of previously stored data.

According to one embodiment, this device can furthermore comprise means of connection of at least a portion of the data to communication means of a carrier of the said products.

An industrial production system can comprise one or more production units, for example one or more factories connected, by communication means, to a computer system such as described above.

An industrial assembly according to the invention can comprise at least one site for using these products, or a production site using these products, at least one site for producing these products or a supplier's site for stocking these products, and a computer system such as described above.

In this way, two, three or more than three using or production sites can be supplied in a rational manner with products or raw material coming from a producer or a distributor.

### BRIEF DESCRIPTION OF THE FIGURES

FIG. 1 shows one embodiment of the invention,

FIG. 2 is a block diagram of computer means of one embodiment of the invention,

FIG. 3 is a diagrammatic representation of a server, a network and computer means for accessing the network,

FIGS. 4A to 4E show screen pages that can appear when using a method according to the invention.

### DETAILED DESCRIPTION OF EMBODIMENTS OF THE INVENTION

Throughout the following description, the term “product” will denote a material intended to be used subsequently in a manufacturing process, in a factory or in a service. Such a product can, for example, be a gas, in particular of the type delivered and stocked in liquid form. An example of a factory is a steelworks, which uses gases for certain stages in the production of steel.

An example of a service is a medical service which also uses certain gases.

Gas can be taken as a product example, but the present invention can relate to other products. According to another example, the steel produced by a steelworks can itself serve, after manufacture, as a raw material and can be used in any type of heavy industry.

In general, the invention applies to any type of industry in which products are used as raw material for the purpose of manufacturing other products, called second or transformed products.

It also applies to all services in which certain products are consumed for the purpose of carrying out a certain service. The example of medical services was given above.

The term “client” or “user” or consumer denotes the person who manages or who is responsible for the laboratory or factory in which these industrial products are used, or in which are located the services supplied with products.

Furthermore the term “manufacturer” will denote the person who manufactures the products used by the client. The invention is also applicable in the case of a distributor or of a non-manufacturing supplier.

In general, the product or raw material in question is manufactured or obtained or firstly stocked on a production or stocking site separate from its place of use.

An intermediate transport stage is therefore carried out.

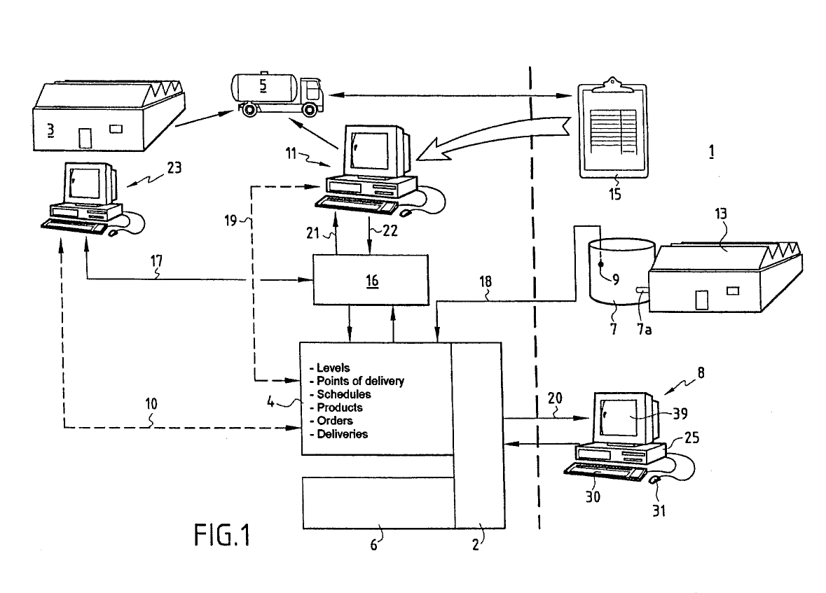

An example of embodiment of a system allowing the use of the invention will be described with reference to FIG. 1, in which the reference 1 denotes the client, or a set of means available to him (to the right of the dashed line), in particular stocking means 7, means 13 of production of second products, and computer means 8.

In FIG. 1, a single stocking unit 7 is shown but the installation may also comprise several stocking units. Means 7a of supplying products contained in the stocking unit 7 connect the latter and the production means 13.

The reference 3 denotes a factory, or more generally means of manufacturing products or raw material, for example a gas. This can also be a stocking unit of a supplier or of a distributor. It is equipped with computer means 23.

The user and the producer or the supplier are not connected by a fixed infrastructure for distributing products as in the case of electricity or the distribution of water.

Another participant is therefore the carrier, provided with means 5 of transport or delivery 5 such as, for example, lorries (or any other vehicle adapted to the transport of the products in question) which will be responsible for delivering to the client 1 products coming from the factory 3. It can also be equipped with computer means 11.

In FIG. 1, the reference 2 denotes a site or a web application, in communication or in a network (for example a private network) with the computer means of the various participants (client, manufacturer or supplier, carrier). The references 10, 17, 19, 20, 21 and 22 denote the corresponding links. In fact, some of these connections are established with an application 16, which will be described below.

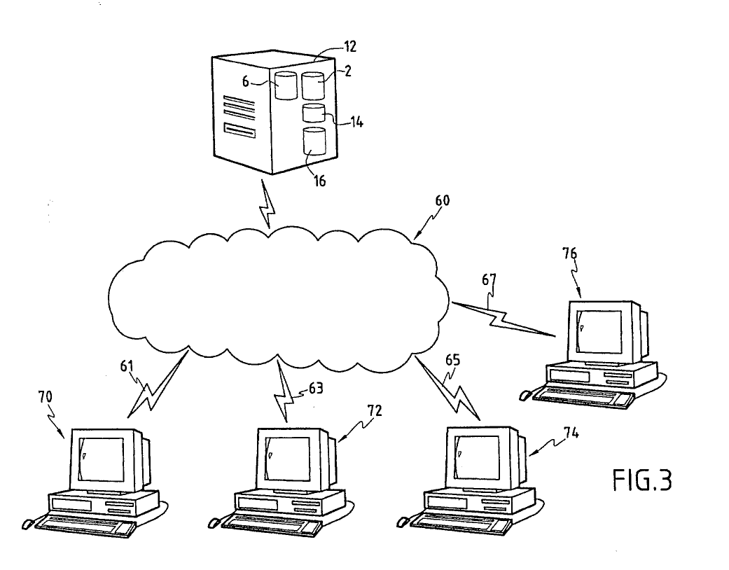

As shown in FIG. 3, this site 2 is hosted on a central computer or server 12 and contains, in particular, a database 4.

Such a database can be updated and comprise, for example, the following information:

the various points of delivery, with the stocking capacities at the points of delivery, the nature of the product stocked at these points, the delivery times,

various schedules such as, for example, a schedule corresponding to a client (his constraints (opening times, accessibility), and/or the known periods of more or less intense use by the latter, and/or a schedule relating to the movement of delivery vehicles, and/or a schedule containing information relating to public holidays, etc.),

the different products that can be offered by the manufacturer or the distributor or the supplier, identified for example by one or more codes, and possibly the corresponding production or stocking sites,

a log of client's orders (dates, quantities),

stocking levels of the products at the user's premises,

deliveries of products, past, current and predicted,

the delivery round plan for the next predicted deliveries,

consumption predictions,

contractual data.

Other information such as official information relating to such and such a type of product can also be used and present on the site 2, for example in a legal or official database 14 (FIG. 3). Certain products cannot for example be delivered during the weekend because of administrative prohibitions, or can be delivered only under certain very specific safety conditions, which can be imposed by the very nature of the product or which can also be imposed by the administration itself.

In addition, application forms for waiving some of these administrative conditions can also be available on the site. In this case, the client or the user, who has access to this information, can download from the database 14 a standard form which he can then complete and present directly to the administrative services able to grant the required waiver.

This database is fed by the different participants in the system or the line starting from the manufacture and ending in the delivery of gases to the user or in the use of the gas by the latter: the manufacturer or the supplier of the gas, the technicians or the teams responsible for distribution and order-taking, the personnel making the deliveries and who provide information on return from these delivery rounds, or even the client himself who gives information, for example on the production rates which are going to vary.

It is also fed by the results of the consumption and/or prediction calculations, carried out by an application 16 that is also hosted on the server 12.

This application makes it possible to calculate, from data contained in the database 4, the consumptions or data relating to consumptions predicted for the future in the different production sites such as site 13. The resultant consumption data will for example be xa tonnes of steel per day (for example over a period of xm months), or will be xl litres of liquid nitrogen over a period of xs weeks. The corresponding delivery data (quantity to be delivered, date and time of delivery, client to be supplied) can also be generated from data in the database 4.

This application 16 can also possibly calculate data on autonomous operation with the product remaining in the stocking means 7.

All of the consumption data relating to several sites of a same user can therefore be assembled in storage means of a same computer system.

Another source of information is constituted by the content or level measurements carried out on the stocking means 7. These measurements can be made manually and then they are transmitted to the server and to the database using means 8. Measuring means 9 can also be used. These means comprise, for example, means of reading the level of products stocked in the means 7, such as an electronic unit. These measurements can be made at regular intervals and are transmitted to the server 12 by communication means. According to an advantageous embodiment, the measuring means 9 can be connected in a network with the server 12, the measurements then feeding the database 2.

According to another variant, the stocking means 7 can furthermore be provided with means of processing data coming from the measuring means 9, these processing means making it possible to carry out prediction calculations on the spot. The resultant data of these calculations are then transmitted by communications means, preferably over a network, to the server 12.

Some of the above information can be accessible only in a secure or confidential manner by certain persons able to connect themselves to the site 2. This is a matter in particular of information coming from the client or from the user himself and which is accessible only to the latter and to the manufacturer. The information relating to the production sites is accessible to the carriers used and to the clients themselves.

Some general information 6 relating to the manufacturer or the supplier can be accessible to any person connecting himself to the site 2, but most of the sensitive or important information in the context of management of the production, the supply and the consumption or use of products will be accessible only to direct participants, namely the manufacturer and/or supplier, the carrier and the client or user.

For confidentiality purposes, secret access keys can be distributed to the clients or users which will enable them to access the information that will be reserved for them.

This can, for each user, be a matter of an identifier and a password.

Data can be exchanged in a secure manner between one of the clients and the server, for example using encryption/decryption software installed in both the computer means 8 and in the server 12. Other solutions can be used in order to make the exchange of data between the client and the server secure.

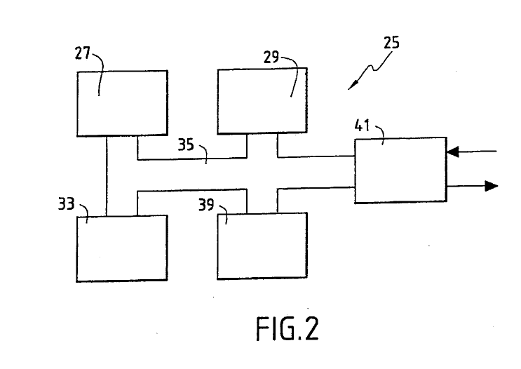

Various users can be connected to the hosting means 2 of these databases. In FIG. 1, one of these users is represented by his portable computer of the PC type 8, the connection with the means 2 being provided by a communications network, for example the Internet network 18, and by means 41 (FIG. 2) of connection to that network (modem or network card).

At the same time, other users 70, 72, 74, 76, shown in FIG. 3, can be connected to the server 12 via connection means 61, 63, 65, 67 and the Internet network 60.

The computer system 8, as well as the systems 70, 72, 74, 76, can be, for example, a commercial micro-computer of the PC type.

Such a system comprises (FIG. 2) a central unit 25, which itself comprises a microprocessor 27, a set 29 of ROM and RAM memories, a hard disk 23, which also has a data storage function, all of these elements being coupled to a bus 35. Program data, for example of the encryption-decryption program for the purpose of the secure exchange of data with the server, can be stored in the memories of this system.

A screen 39 makes it possible to display information on the data entered into the system by an operator, and the data supplied by the databases in response to the data entered by the operator. Presentation pages are displayed successively during the execution of the method according to the invention. These pages can make it possible, in some cases, to enter data such as one or more secure access codes, such that only the authorized persons can connect to certain areas of the site 2 or can have access to certain information in the database 4.

The system also has control peripherals and, in particular, a keyboard 30 and a mouse 31. Other means for selecting an area or a field of a page displayed on the screen 29 can also be used, for example any means allowing a selection to be made by tactile contact on the screen.

The server 14 has an overall structure of the same type, with a processor or processors, data storage areas (some of which are denoted in FIG. 3 by the references 2, 6, 14, 16).

In one memory area of the server there can be stored the program instructions or data for using a method according to the invention.

This data or these instructions can be transferred into a memory area of the server from a diskette or any other medium able to be read by a computer (for example: hard disk, Read Only Memory ROM, Dynamic Random Access Memory DRAM or any other type of RAM memory, compact optical disk, magnetic or optical storage unit).

Program data, for example encryption-decryption program data for the purpose of a secure data exchange with the server, can be stored in the memories of this system.

In response to the user's instructions, a connection is made between the system 8 and the means 2 which host the database and, possibly, the programs to be used for executing certain stages or certain calculations, for example the calculation or prediction of consumptions stages.

A session can therefore be initialized, during which, in response to data entered by the user, the system 12 will send to that user data selected by searching in the database or resulting from a calculation carried out by the server 12 (application 16).

The session may or may not be interactive.

Thus the following information can be retrieved by or supplied to the client:

characteristics of his own site (methods and equipments used, capacity of stocking means 7),

log of the different orders and/or deliveries that have already been made to him, for example by order and/or delivery notes available on line on the site, with, for example, mentions of the quantities ordered and/or delivered, order or delivery dates),

information relating to the products that have already been actually delivered to him, such as for example an analysis of the product (exact composition) and/or certificate of conformity,

levels of products in the stocking means 7 which are available to the user.

The following can also be retrieved: the consumption prediction and/or delivery information, and/or consumption analyses, and/or the reciprocal undertakings of the parties.

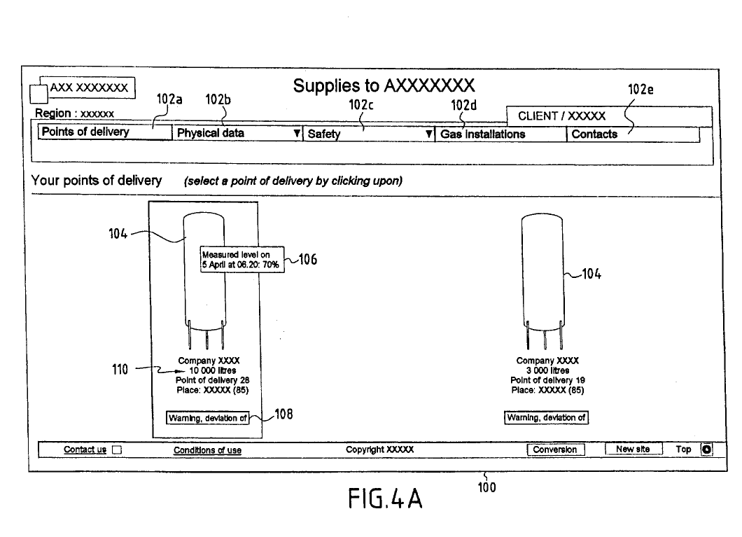

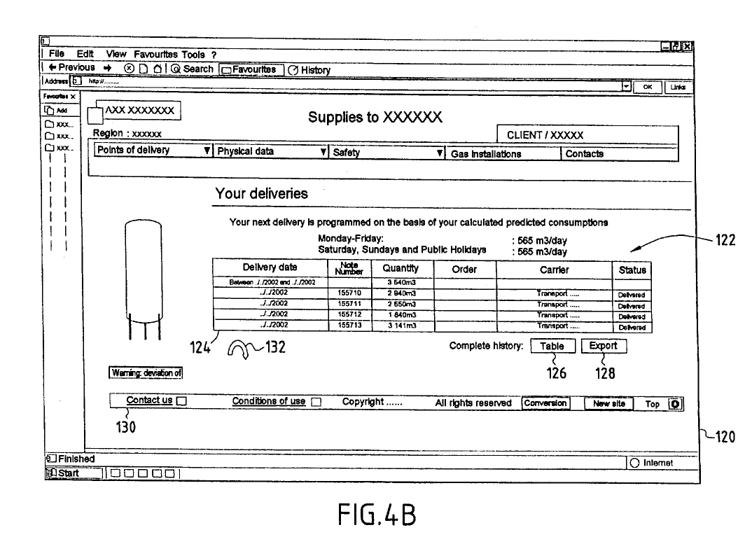

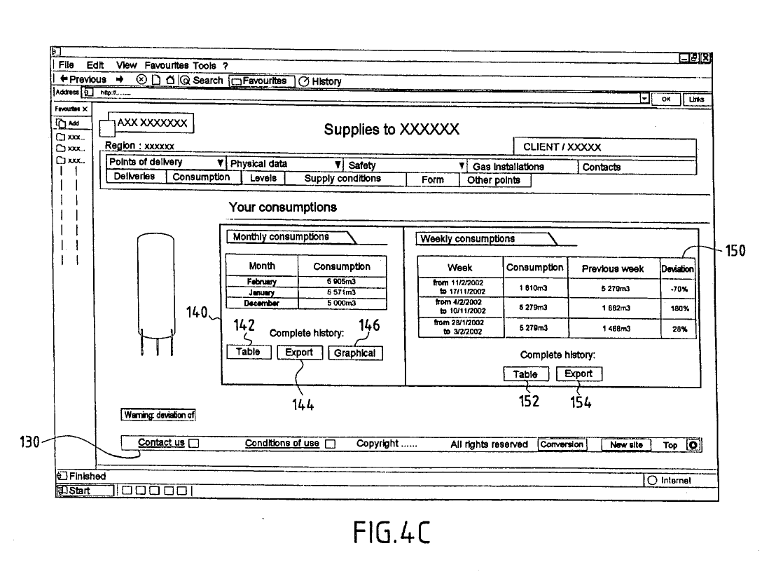

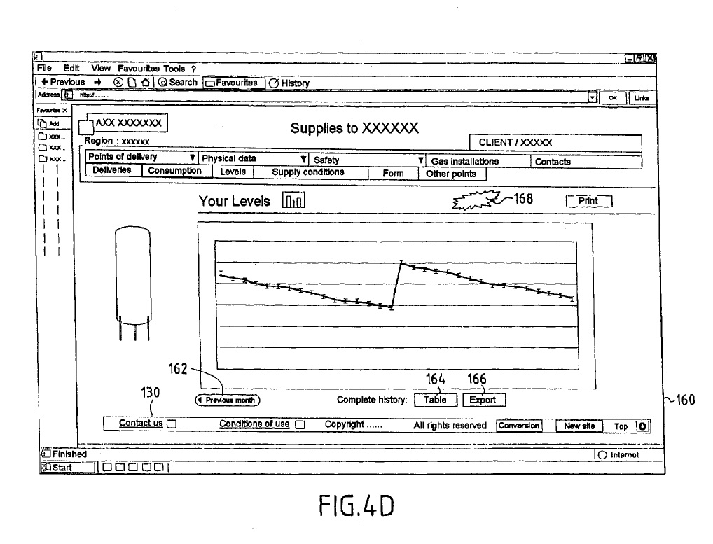

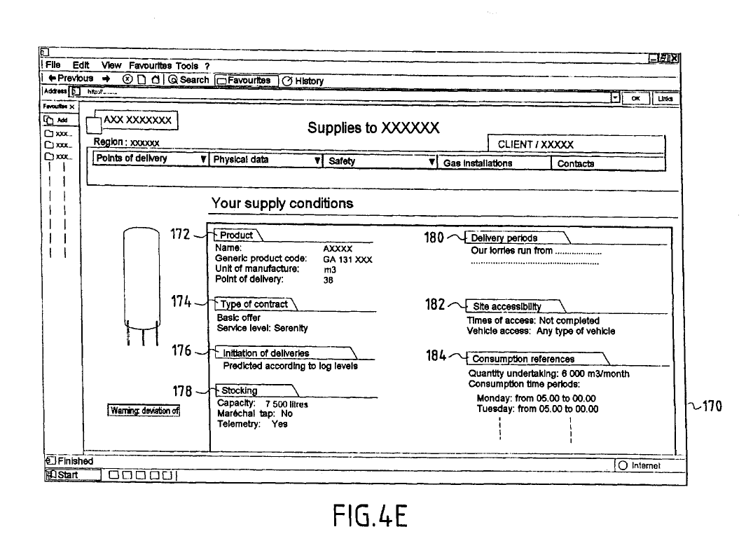

Examples of these information retrievals will be given below with reference to FIGS. 4A to 4E.

With regard to the characteristics of his own site and the levels of products in the stocking means 7, the following observation will be able to be made. The person who consults the site on line does not necessarily know, immediately, all of the production resources and all of the stocking capacities that he or she has.

This is the case, in particular, for activities using geographically dispersed and complex installations, for example steel production units disposed in different towns.

The same applies with regard to the possibility of measuring directly the levels of products remaining in the stocking means which the person consulting the site has. These stocking means can therefore be equipped with automatic measuring means 9 connected to the communications network and thus to the site 12 and to the database 4. It is then easier for a physical person working for the user (the latter being, for example, a company that carries out a production process) to connect himself to the site 2 than to go to each storage tank and check the levels of gases or products present.

To this basic information can be added information resulting from the use of specific programs able to make calculations using the basic information. This is, for example, a matter of calculations (carried out by the application 16) of consumption and/or delivery prediction, or even the operational autonomy with the product remaining in the stocks.

It can also be a matter of programs or means of initiating alarms when a level approaches a maximum or minimum level that must be present in the stocking means or when a consumption exhibits a deviation with respect to a reference datum or reaches a certain value between two consumption periods.

Using the means 8, the user himself can enter new data on the site or modify data already existing on the site.

He can, for example, enter an order not yet foreseen by specifying the desired date and quantity, or he can give information regarding his future consumption, or indicate a change in the rate of his consumption, or indicate a passing through of a safety stock level.

Some of this information can in its turn have an effect on the consumption prediction calculations and/or delivery calculations, or on the calculations of operational autonomy with the product remaining in stock.

Other information can have an effect on a delivery schedule, for example if the user announces a new operational mode of a production site (in the case of a change of work rate) or even a temporary closure of such a site for technical closedown.

The invention therefore makes it possible to share the same technical information immediately between several persons or between several industrial sites which must adapt their technical and industrial activities as quickly as possible on the basis of this information.

In particular, it is a matter of information relating to past and/or present and/or future consumption rates of an industrial consuming site 13, and/or relating to operational autonomy, and/or to safety levels, and/or it is a matter of information relating to the whole of the raw material supply system (for example: location of production factories 3 or of the supplier's stocking units and/or production capacities of these factories or stocking capacities of these stocking means, and/or predicted deliveries of that material, and/or technical characteristics of the available material, for example the nature or the name or the identification of that material) which that industrial consuming site needs.

Among the persons, or the industrial sites concerned, which have access to this common information, there appears not only the industrial sites consuming products or raw material, but also the industrial producer or the manufacturer or the supplier of these products or of that same raw material, or even the carrier responsible for delivering to the industrial consuming site or sites.

Knowledge of the production or stocking capacities of the production or stocking means 3, and/or of the predicted deliveries and/or of the level of his own stocks allows the user to adapt his production or the provision of his services. He can thus avoid starting the production of certain products for which the raw material will not be available at a given time, or he can, on the contrary, start a production of products knowing that the raw material is available or will be available soon. The same applies to services: the user can therefore take orders for certain services or, on the contrary, can refuse them according to the availability of the material produced by the means 3.

Another participant in the supply line of products to the final user is the carrier or the person responsible for the transport of these products. That person has means of access to the site similar to those available to the user. That person therefore has the same information as the latter. Furthermore, that person has access to information relating to other industrial sites to which deliveries must be made.

By connection to the site 2, using means 11, that person can identify the deliveries in progress, or the next deliveries to be made, and can therefore adapt his transport capacity to the present or future needs.

The carrier can also obtain information relating to the requirements of users or to the deliveries to be made in the near future. In fact, as already explained above, the application 16 makes it possible to produce data relating to the deliveries to be made. This therefore makes it possible to print out delivery round sheets from this same information and to print out the associated delivery notes (with, in particular, the name and address of the client and the nature and the quantity of the product to be delivered).

After delivery, it is possible to enter data in the base 2, such as the quantities actually delivered and the levels possibly measured after delivery. This information can have been noted on a delivery note 15, signed by the client at the time of the delivery and is recorded, for example, in the computer means 11 on return from the delivery. There is then a transmission of this information to the database 4.

This entry can be made either at the time on return as explained above, or using computer means installed in the delivery lorries.

The same apples to the supplier or the manufacturer, who has access to the information in the site 2 or in the database 4 by links 10, 17. He also can adapt the manufacture of products by the factories 3, or the management of his stocks of products, on the basis of the information available on the site (in particular: requirements expressed by the consumers or users and/or possibly calculated consumption prediction data).

The manufacturer or suppler of material or of products to be delivered to the user also has use of information gathered on the site and can adapt his own production, or his own orders or his own stocks, on the basis of requirements, or of the necessary quantities, expressed by the users or requirements predicted by consumption prediction calculations. Thus, in the case of a growth in these requirements or these quantities, the production, or the order by the supplier, for material or products is increased, whereas it is reduced in the case in which an overall reduction in requirements is observed.

Furthermore, this makes it possible to avoid producing or ordering surplus products which will present, on the one hand, a stocking problem and possibly a safety problem, and which, on the other hand, may be perishable.

The invention therefore makes it possible to minimize the stocking time of products at the manufacturer's or supplier's premises, and to deliver these products to the user as quickly as possible, not only after the requirement possibly revealed by the user, but also after consumption.

Various participants in the system can connect themselves simultaneously to the database 2 or to the computer hosting it.

For example, in FIG. 3, four users 70, 72, 74, 76 are shown, who can have very separate geographic locations and who are connected, via the Internet 60 and specific connections 61-67, to the computer 2.

Two users 70, 72, for example two industrials in very different fields, the carrier 74 and the manufacturer or the supplier 76 can be connected. The data supplied by the users 70, 72 make it possible to update the quantities to be manufactured by the manufacturer or the supplier 76 and to be delivered by the carrier 74.

All of the users of the system can therefore be connected in a network to a central computer system 12. This is particularly the case of a plurality of producers or of users forming a set of production means 13 or of factories or a set of using sites connected, by communications means, to the system 12. Each factory or each using site can adjust its own production or activity on the basis of the production data of the manufacturer or the stocking data of the supplier present on the site or the computer 12, just as the production of the manufacturer or the stocking of the supplier can be adapted on the basis of the requirements of the using client or clients or of the factories.

Various means can be used instead of the computer means 8, 11, 23. For example, mobile telephones can also be used for transmitting certain data, in particular in SMS form.

FIGS. 4A to 4E show various screen pages that can be displayed by an operator during the use of a method according to the invention.

A first input page 100 (FIG. 4A) makes it possible to present, for a given user, various tabs 102a-e making it possible to select and execute various applications such as, for example: distribution and equipment of the points of delivery (tab 102a), physical data on the products used (tab 102b), indication relating to safety measures to be used with such and such a product (tab 102c), description of the installations operating with the fluid used (gas installations, tab 102d), access to various items of information (tab 102e).

Thus, on the page shown in FIG. 4A, a point of delivery has been selected. The stocking means located in that place is represented diagrammatically on the corresponding page (reference 104). Information 106 relating to the stock level and the data on which this level was observed can also appear on this page. An indicator, or an inset 108, presents the user with a consumption alarm signal relating to the stocking means 104, or an alarm signal in the case of an exceptional event. Also indicted in the field 110, below the diagram 104, are the nature and quality of the fluid stocked in the means 104.

The delivery data can also be represented, as shown in FIG. 4B.

This page gives information relating to the calculated predicted consumptions (see zone 122 on page 120), these calculations being carried out according to a predetermined algorithm, for example according to the application 16 shown in FIG. 1.

A table 124 shows, successively from left to right:

the different delivery dates (past and predicted),

the corresponding delivery note number,

the quantity delivered or to be delivered, the name of the carrier,

the status of the delivery (delivered or delivery planned).

Various items of information associated with each of these deliveries can also be displayed: batch number and/or source of the product, and/or analysis result, and/or copy of the paper delivery slip if the delivery has already been made.

A tab 126 makes it possible to obtain a summary of these delivery notes, for example a log of these notes over a given period, for example a year, with, for each delivery, the date, the delivery number, the quantity delivered, the order reference, etc.

Another tab 128 makes it possible to implement a function to “export” displayed or selected data to another application or to a page.

Various tabs 130, shown at the bottom of the page in FIG. 4B, make it possible, for example, to access another page in order to enter an order for the product, or furthermore to access a page in order to reproduce data relating to a variation in the user's consumption.

Another tab 132, represented in FIG. 4B by an arrow, makes it possible to validate a proposal for re-provisioning made by the supplier.

FIG. 4c shows a page which collects various items of information relating to the user's consumptions.

Thus, in a box 140 there can be represented the consumptions of the product during several successive months. Such a table can be established from the delivery notes. Tabs 142, 144, 146 make it possible to select a representation in the form of a table or an export of selected data or even a graphical representation of the consumptions.

Another table 148 makes it possible to represent consumptions over a period different from that of table 140, for example a weekly consumption. This weekly consumption is, for example, calculated from level readings and delivery notes. A calculation of variation of consumption between two successive periods (between two weeks in the present case) can also be carried out and presented in a column 150. Such a deviation can be represented in a particular colour if it reaches a predetermined threshold, for example 20%.

Here again, tabs 152, 154 make it possible to select, on the one hand, a representation in table form or, on the other hand, to export certain data to another page or another application.

Here again, the lower bar 130 makes it possible to access various other applications as already mentioned above.

Page 160 of FIG. 4D is a graphical representation of the variation in the fluid level in the container 104. This graph corresponds to a given period and a tab 162 makes it possible to select other time periods.

Two tabs 164 and 166 make it possible, on the one hand, to select a representation in table form and, on the other hand, to export certain data to another application or another page.

The bar 130, at the bottom of the page, offers the same possibilities as already described above.

A tab 168 makes it possible to carry out a calculation of autonomy at constant consumption rate, or autonomy simulations with rate variations.

FIG. 4E collects, on a page 170, various conditions for supplying the product used by the user. The following can be represented:

the nature of the product (field 172),

the type of contract (field 174),

the method of initiating deliveries (field 176),

stocking conditions (for example: capacity and miscellaneous technical data on the equipment of the stocking means, field 178),

the delivery periods (field 180),

the site accessibility conditions (field 182),

certain references relating to consumption, such as the time periods (field 184).

1. Method of adapting the production, by a unit (3) for producing at least one product, to the consumption of the said product by at least one consumer (13) of that product, comprising:
the storage, in storage means (4), of data relating to at least the status of stocks of the said product contained in stocking means (7) of the said consumer and to that consumer's product requirements,
the calculation of consumption prediction data on the basis of the preceding stored data,
the variation of production, by the production unit (3), on the basis of the preceding consumption prediction data.

2. Method for supplying a consumer (13) with at least one product consumed by the said consumer, comprising:
the storage, in storage means (4), of data relating to at least the status of stocks of the said product contained in stocking means (7) of the said consumer and to that consumer's product requirements,
the calculation of consumption prediction data on the basis of the preceding stored data,
the generation (21) of delivery data of the said product on the basis of the calculated consumption prediction data.

3. Method for adapting a utilization, by a unit (13) consuming at least one product, comprising:
the storage, in storage means (4), of data relating to at least the status of stocks of the said product contained in stocking means (7) of the said consuming unit and to the product requirements of that consuming unit,
the variation of consumption, by the consuming unit (13), on the basis of the preceding data.

4. Method according to one of claims 1 to 3, the said storage means furthermore comprising technical characteristics data relating to manufacturing or stocking units or to production means (3) of the said product.

5. Method according to claim 4, the said technical characteristics data relating to manufacturing (3) or stocking units or to production means (3), comprising at least one item of data relating to the location of the production and/or stocking units and/or at least one characteristic of the said product.

6. Method according to one of claims 1 to 5, the said product being a gas.

7. Method according to one of claims 1 to 6, furthermore comprising a stage of packaging in transport means (5), and then a stage of transport of the said product to the said consumer or the said consuming unit (7, 13) of that product.

8. Method according to claim 7, furthermore comprising a stage of storage, in storage means (4), of data relating to at least a quantity of product actually delivered.

9. Method according to claim 7 or 8, comprising, after transport, a stage of transferring the said product into the stocking means (7).

10. Method according to one of claims 1 to 9, comprising a stage of measuring the quantity of product available in the said stocking means (7), and the transmission of measurement data to the said storage means (4).

11. Method according to claim 10, furthermore comprising a corresponding modification, following the transmission of measurement data, of stored data (4) relating to the status of the stocks.

12. Method according to one of claims 1 to 11, furthermore comprising a stage of sending, into the storage means (4), by the consumer or from the consuming unit, data relating to that consumer's or that consuming unit's product requirements.

13. Method according to claim 12, furthermore comprising a stage of calculating consumption prediction data, on the basis of modified data relating to product requirements.

14. Method according to one of claims 1 to 13, furthermore comprising a stage of sending, into the storage means (4), by the consumer (13) or from the consuming unit, ordering data of the said product.

15. Method according to one of claims 1 to 14, the said storage means furthermore comprising technical characteristics data on the production means (13) of the said consumer using the said product.

16. Method according to claim 15, the said technical characteristics data on the production means (13) comprising at least one item of data on the consumption rate and/or on variation of this rate and/or an item of data on safety level or quantity in the stocking means (7).

17. Method according to one of claims 1 to 16, the said storage means furthermore comprising data relating to deliveries of the said product.

18. Control system for at least one production (3) or stocking unit of at least one product, on the basis of consumption data of the said product by at least one unit (13) consuming this product, comprising:
storage means (4), for storing data relating to at least the status of stocks of the said product contained in stocking means (7) of the said consumer and to the product requirements of this consumer,
means (16) of calculating consumption prediction data on the basis of the preceding stored data,
means of transmitting this data to the said production (3) or stocking unit.

19. Production unit of industrial products comprising:
means (3) of production of the said products,
means (2, 23, 17, 10) of communication to establish communication with a system according to claim 18.

20. System for controlling the provisioning of a unit (13) consuming a product, comprising:
storage means (4), for storing data relating to at least the status of stocks of the said product contained in stocking means (7) of the said consuming unit (13) and to the product requirements of this unit,
means (16) of calculating consumption prediction data on the basis of the preceding stored data.

21. System according to claim 20, furthermore comprising means (16) for calculating delivery data of the said product on the basis of the calculated consumption prediction data.

22. Industrial production unit comprising:
means (7) of stocking products, referred to as first products,
means (13) of production of second products, obtained from the said first products,
means of communication for establishing communication with a system according to claim 20 or 21.

23. Unit according to claim 19 or 22, the said communication being secure.

24. System or unit according to one of claims 18 to 23, the storage means furthermore comprising data relating to technical characteristics of at least one production unit of the said product.

25. System or unit according to one of claims 18 to 24, furthermore comprising means (9) for measuring a quantity or a volume of products contained in the said stocking means (7).

26. System according to claim 25, furthermore comprising means (18) of communication between the said measuring means (9) and the said storage means or between the said measuring means (9) and computer means (12) containing these storage means.

27. System or unit according to one of claims 18 to 26, furthermore comprising means (2, 25) for establishing a secure link (10, 17, 20, 21, 22) with communications means (8, 11, 23) of a consuming unit (5, 13) and/or with means of communication (23) of a products production unit (13) and/or with communications means (11) of a transport means (5) management unit.
